(19) United States
(12) Patent Application Publication
(10) Pub. No.: US 2008/0109272 A1
(43) Pub. Date: May 8, 2008

(54) Apparatus, System, Method and Computer Program Product for Analysis of Fraud in Transaction Data

(76) Inventors: Anshul Sheopuri, Jersey City, NJ (US); Paolina Centonze, Yorktown Heights, NY (US); Sai Zeng, Hawthorne, NY (US); Jose Gomes, Douglaston, NY (US); Ioana Boier-Martin, Hawthorne, NY (US)

Correspondence Address: HARRINGTON & SMITH, PC, 4 RESEARCH DRIVE, SHELTON, CT, 06484-6212, US

(21) Appl. No.: 11/557,520

(22) Filed: Nov. 8, 2006

(51) Int. Cl. G06Q 10/00; G07F 17/10

(52) U.S. Cl. 705/7

(57) ABSTRACT

In one non-limiting aspect thereof the exemplary embodiments of this invention provide a computer-implemented method to make a decision as to whether a particular claim submitted by a first economic agent for approval by a second economic agent may be a fraudulent claim. The method includes applying statistics to information representing a proxy of fraud to generate an estimate of a probability of fraud for the particular claim; updating the estimate of the probability of fraud using decision making under uncertainty that is based at least in part on at least one type of additional information; applying game theory to the updated estimate of the probability of fraud to model strategic behavior between the first and second economic agents; and generating a recommendation to audit or not audit the particular claim. The proxy of fraud may be imperfect proxy of fraud, such as is found in nascent industries.

### TECHNICAL FIELD

The teachings in accordance with the exemplary embodiments of this invention relate generally to fraud detection systems, methods and computer program products and, more specifically, relate to audit management systems employing fraud detection in transaction data.

### BACKGROUND

A number of researchers have modeled fraud detection in the medical and automobile insurance environments, as well as for tax claims (using Discrete Choice models). For example, in “Strategies for detecting fraudulent claims in the automobile insurance industry”, Stijn Viaene, Mercedes Ayuso, Montserrat Guillen, DirkVan Gheel, Guido Dedene. OR Applications, European Journal of Operations Research., 2005, model fraud in the auto insurance industry using a Logit model. In “Outlier Detection by Active Learning”, N. Abe, B. Zadrozny, J. Langford, The Twelfth ACM SIGKDD International Conference on Knowledge Discovery and Data Mining, August 2006, Philadelphia, USA, adopt a classification based approach. In “A Comprehensive Survey of Data Mining-based Fraud Detection Research”, Clifton Phua, Vincent Lee, Kate Smith, Ross Gayler, 2005, a survey is made of fraud detection. Phua et. al provide the following definition of fraud and motivation for the need for fraud detection: “The term fraud refers to the abuse of a firm's process without necessarily leading to direct legal consequences. In a competitive environment, fraud can become a business critical problem if it is very prevalent and if the prevention procedures are not fail-safe. Fraud detection, being part of the overall fraud control, automates and helps reduce the manual parts of a screening/checking process.”Recently, some researchers have used game theory to model corruption and fraud (see “Strategic Analysis of Petty Corruption: Entrepreneurs and Bureaucrats”, Ariane Lambert-Mogiliansky, Mukul Mujamdar and Roy Radner, Working Paper No 2005—40, Paris-Jordan Sciences Economiques, 2005).

One significant drawback of the existing methods is that they do not provide a framework or methodology for analysis when a random subset of the population which has been segmented is not available or is only partially available.

### SUMMARY OF THE EXEMPLARY EMBODIMENTS

The foregoing and other problems are overcome, and other advantages are realized, in accordance with the non-limiting and exemplary embodiments of this invention.

In a first aspect thereof the exemplary embodiments of this invention provide a computer-implemented method to make a decision as to whether a particular claim submitted by a first economic agent for approval by a second economic agent may be a fraudulent claim, comprising: applying statistics to information representing a proxy of fraud to generate an estimate of a probability of fraud for the particular claim; updating the estimate of the probability of fraud using decision making under uncertainty that is based at least in part on at least one type of additional information; applying game theory to the updated estimate of the probability of fraud to model strategic behavior between the first and second economic agents; and generating a recommendation to audit or not audit the particular claim.

In a second aspect thereof the exemplary embodiments of this invention provide a computer program product embodied on a tangible memory media that comprises program instructions the execution of which by a data processor result in operations to detect if a particular claim submitted by a first economic agent for approval by a second economic agent may be a fraudulent claim. Execution of the computer program product comprises operations of: applying a statistic model to information representing an imperfect proxy of fraud to generate an estimate of a probability of fraud for the particular claim; updating the estimate of the probability of fraud using decision making under uncertainty that is based at least in part on at least one type of additional information; using game theory with the updated estimate of the probability of fraud to model strategic behavior between the first and second economic agent and generating a recommendation to audit or not audit the particular claim.

In a further aspect thereof the exemplary embodiments of this invention provide a data processor that includes an input for receiving a claim submitted by a first economic agent for approval by a second economic agent; a claim processing unit coupled to the input and adapted to detect if the claim may be a fraudulent claim; and an output coupled to the claim processing unit for outputting a recommendation to audit or not audit the claim; where the claim processing unit is adapted to apply a statistic model to information representing an imperfect proxy of fraud to generate an estimate of a probability of fraud for the claim, to update the estimate of the probability of fraud using decision making under uncertainty that is based at least in part on at least one type of additional information, and to use game theory with the updated estimate of the probability of fraud to model strategic behavior between the first and second economic agents.

In another aspect thereof the exemplary embodiments of this invention provide a computer program product embodied on a tangible memory media that comprises program instructions the execution of which by a data processor result in operations to make an auditing decision for a claim submitted by a claimant. The operations include estimating β from a statistical model, M; computing p_{R} using the estimate β of M; computing p_{H} from H; using a Weak Axiom of Revealed preferences, computing X_{R} and X_{H}; using update mechanism Φ, compute X′_{R}; computing p_{R}*; and making an affirmative audit decision if bₚ_{^{*}}(x_{R})=1.

### BRIEF DESCRIPTION OF THE DRAWINGS

The foregoing and other aspects of the teachings of this invention are made more evident in the following Detailed Description, when read in conjunction with the attached Drawing Figures, wherein:

FIG. 1 illustrates an environment that is descriptive of a typical current process for handling T&E expenses.

FIG. 2 is a logic flow diagram that is descriptive of a system, method and computer program product in accordance with the exemplary embodiments of this invention for performing fraud detection in transaction data.

FIG. 3 is a logic flow diagram that is descriptive of operation the system, method and computer program product in accordance with the exemplary embodiments of this invention.

FIG. 4 is a block diagram of a computing system that is one suitable environment in which the invention may be embodied.

### DETAILED DESCRIPTION

By way of introduction, the exemplary embodiments of this invention solve the problem of decision making, such as Discrete Choice Decision Making, in transactional data. As a non-limiting example, travel and entertainment (T&E) expense data typically includes expenses such as travel (airfare, car rental, etc.),food and entertainment (business meals) and seminar costs, which may collectively be referred to as transactional data. By “transactional data” what is meant is a collection of items or records. In the context of the ensuing description of the exemplary embodiments of this invention “Discrete Choice Decision Making” refers to a process of making a discrete choice of each data collection or bundle. For example, in audit management one decides which claims to submit to any formal or informal mechanism of further evaluating the authenticity of the claim. A “claim” refers to any reimbursement sought for expenses incurred.

In the special case of nascent industries the exemplary embodiments of this invention are particularly useful. As employed herein a “nascent industry” is intended to be a setting where segmentation (into two or more discrete choices for the dependent variable) of a random subset of the population is not available, or is only partially available. In T&E expenses, for example, a random subset of the population is not available where individuals may be segmented into honest and dishonest. This case can be contrasted to, for example, the insurance industry, where there is a substantial preexisting body of data representing valid claims and fraudulent claims.

With respect to T&E, the inventors are not aware of any prior application of Discrete Choice models, Decision making under uncertainty, or Game Theory. While many firms adopt ad hoc reporting techniques, based on visualization and tabulation of raw data, more analytically sophisticated approaches have not been reported. At least one approach appears to employ a check for duplicate claims, as well as providing threshold-type reports. However, the metrics used for these reports is unclear. Another approach provides statistical information of the location where an expense was incurred to enable the auditor to benchmark the particular claim information against.

The exemplary embodiments of this invention provide a method and system for discrete choice decision-making, and are especially useful with, but are not limited for use with, the detection of fraud in nascent industries. The method and system support predictive modeling of discrete choice decision making in transaction data, and combine Statistical modeling, Optimization, and Game Theory. As employed herein, statistical modeling comprises the use of Discrete Choice models such as Logit or Probit, optimization refers to decision making under uncertainty, and game theory includes the use of a Stackelberg Game. A Discrete Choice model is herein considered to be an econometric model in which the economic agents are presumed to have made a choice from a discrete set. Decision making under uncertainty is considered to be an optimization problem in which a decision maker makes a decision in the face of incomplete information. A Stackelberg Game is herein defined as a duopoly model in economics with two players, a leader and a follower. The leader moves first and makes a decision. The follower observes the leader's choice and then makes his or her decision. A description of the Probit model can be found in Greene, William, Econometric Analysis, 2003, p. 663, equation 21-6.

The use of the exemplary embodiments of this invention allows for an auditor to decide whether a particular claim is potentially fraudulent based on fundamental theory in statistics, optimization and game theory, and furthermore enhances the automation ofdiscrete choice decision making (e.g., audit management). The use of the exemplary embodiments of this invention further provide a systematic approach to deal with the problem of fraud detection, especially in the context of nascent industries, and thus also permit an analysis for fraud detection in T&E, where such a framework was previously lacking.

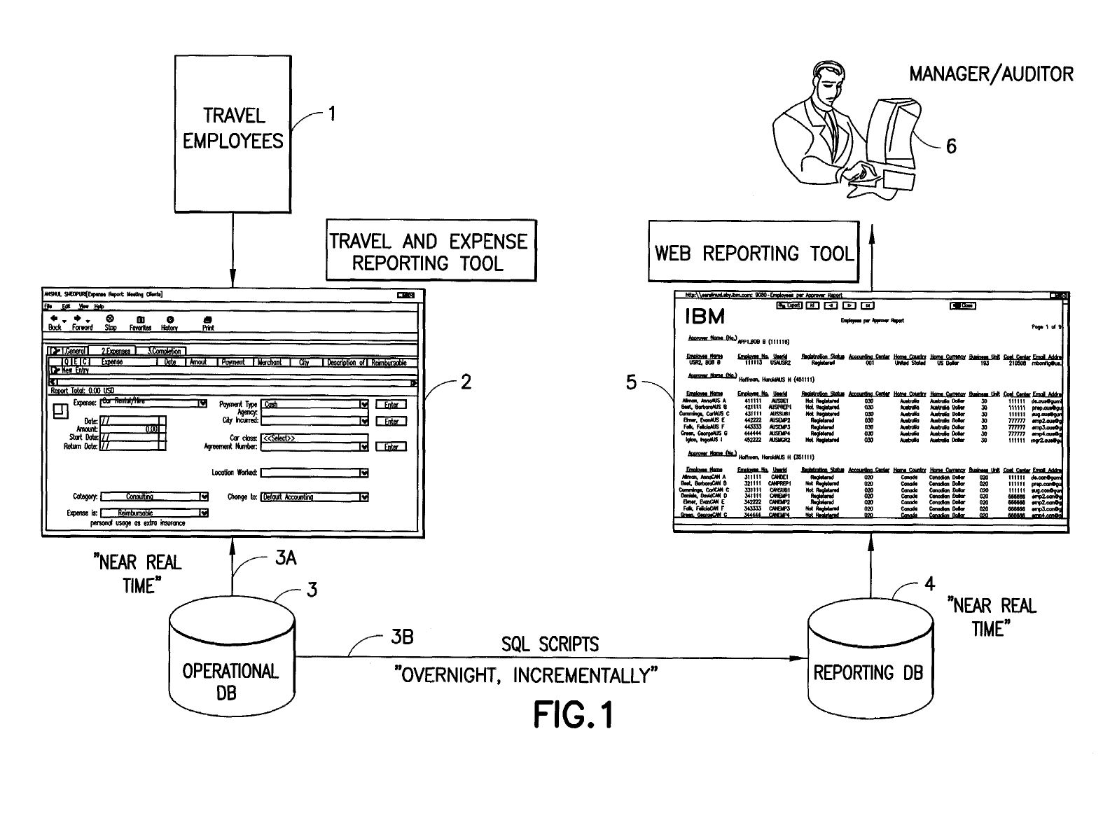

Reference is made to FIG. 1 for illustrating an environment that is descriptive of a typical current process for handling T&E expenses. Employees 1 submit the claims (e.g., travel-related expenses) through a T&E tool 2, which is used to populate (in near real time) tables in an operational database 3 via a link 3A. Subsequently (e.g., overnight) relevant data attributes are extracted from the operational database 3 and sent over link 3B as, for example SQL scripts to populate tables in a reporting database 4. These relevant data attributes are then viewed by an auditor/manager 6 through a web reporting tool 5 by selecting a report of the auditor's choice.

The exemplary embodiments of this invention may be practiced in, as examples,one or both of the links 3A and 3B of FIG. 1.

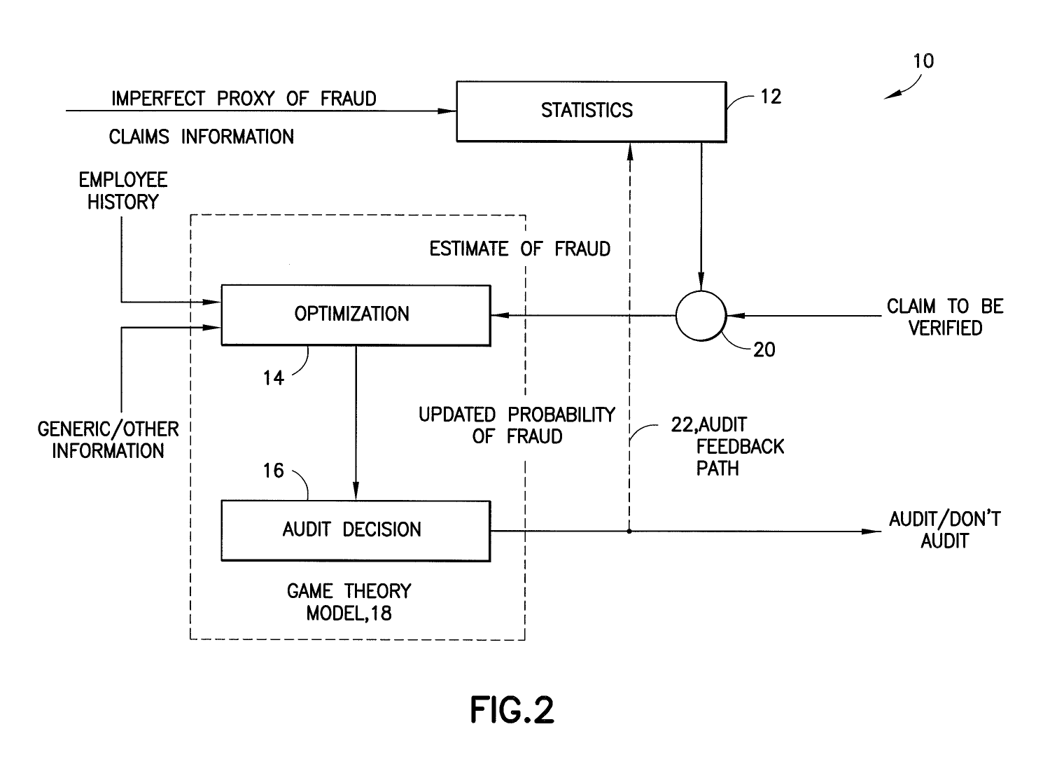

Reference is made to FIG. 2 for showing an overall logic flow diagram that is descriptive of a system 10, method and computer program product in accordance with the exemplary embodiments of this invention for performing fraud detection in transaction data. Relevant transaction data is input to the system 10 and the output is a decision (and reason) for an audit/no audit decision. The transformation from the system 10 input to output is achieved by a statistical model 12, followed by an optimization unit 14 and an audit decision unit 16. The optimization unit 14 and audit decision unit 16 are preferably embodied in a game theory model 18, such as one that is based on, as a non-limiting example, a Stackelberg Game model.

In operation, a typically imperfect proxy of fraud as well as claims information is input to the statistics unit 12, which provides an output to a fraud estimation unit 20 that also receives as an input a certain claim to be verified (a new expense report entered by one of the travel employees 1 that is to be verified). The imperfect proxy of fraud can comprise one or more of an audit history and historical corporate expense reporting information. The output of fraud estimation unit 20 is an estimate of fraud that is input to the optimization unit 14, that also receives as inputs an employee history (at least for past claims) and other information such as generic information (e.g., the cost of an audit). An updated probability that the particular claim is fraudulent is output from the optimization unit 14 to the audit decision unit 16 which provides the audit/don't audit decision that is the output of the system 10. This decision can then be contemplated by the manager/auditor 6 to determine whether a particular claim may require further scrutiny. Note that there may be an optional audit feedback path 22 from the output of the audit decision unit 16 to the statistics unit 12 so that the predictive model is enabled to continually learn and improve.

As will now be described in further detail, the exemplary embodiments of this invention provide a heuristic algorithm that combines fundamental ideas from statistics (discrete choice models), optimization (decision making under uncertainty) and game theory (Stackelberg game) for fraud detection, which is particularly useful in the case of nascent industries.

The exemplary embodiments assume the presence of a dataset related to employee travel expenses over a period of time that includes detailed information about the expense type, amount, location, currency, receipt limit requirements and payment type, as representative data categories.

A major drawback of missing information is the unavailability of a random subset of the data where claims have been partitioned into fraudulent and non-fraudulent after a complete audit. This is a serious drawback from the perspective of modeling. Not only does it hinder the development of a model for fraud detection, but also prevents effective validation for any model that might be developed. However, the dataset contains an imperfect proxy of fraud, an indicator audit variable which is flagged by certain ad hoc rules that may trigger an audit, as well as a manual over-riding decision.

The preferred embodiments employ a predictive model that enables an auditor to decide whether a claim should be audited or should not be audited. To overcome the deficiencies in the dataset mentioned above, at least two approaches could be used. The first is to collect the data by randomly auditing a subset of the population and classifying them as honest and dishonest. The second is by building a model that attempts to overcome this problem. Based on practical considerations, the second approach is preferred.

An underlying fundamental aspect of the procedure is the use of a ‘classical’ statistical technique to build a model for fraud detection. However, due to the dataset deficiencies it is preferred to model the decision-making process of the players directly, since it is not captured in the statistical model due to the use of an imperfect audit proxy. Assuming the players to be rational economic agents, it is preferred to model the interaction between the auditor 6 and the employee 1 as a game. In this manner one updates estimates of fraud by modeling the strategic behavior of the players, and also updates the estimates of fraud using the employee's historical information through a heuristic argument. The updated estimates of fraud enable the auditor 6 to make the auditing decision.

The description of the model embodied in the system 10 is best undertaken with a preliminary review of relevant theoretical concepts. It is preferred to use a discrete choice model, Logit (see Greene, W. 2003. Econometric Analysis. Fifth edition) and demote the set of factors that explain the audit decision by x (all vectors are column vectors unless otherwise stated) and the binary decision by Y (Y=1 or Y=0) so that:

$$Prob ( Y = 1 \vert x ) = Λ ( {x}^{T} β ) = \frac{{e}^{{x}^{T} β}}{{e}^{{x}^{T} β} + 1} ,$$

where the set of parameters β reflects the impact of the changes in x on the probability and Λ(.) is the cumulative distribution function of the well-known Logistic Regression (Greene(2003), Pp 665). In the context of T & E, x would be the set of factors which determine the auditing decision (Y=1). These factors are described in detail below.

As was discussed above, this framework has been widely studied and is well-understood, even in the context of fraud detection. However, the exemplary embodiments of this invention depart from the usual setting in that there is no random subset that has been partitioned into honest and dishonest claims, as is the case in a nascent industry. To understand how this problem is overcome, it is instructive to review certain recent literature on fraud and corruption.

Lambert-Mogiliansky et. al (2005) study corruption using Game Theory. A simplistic starting point of their analysis is a Stackelberg game between a Bureaucrat (B) and an Entrepreneur (E). (E) has to seek clearance on a project from (B). (E) has private information on the value (profit) that he may derive from the project. (B)'s decision is to decide how much bribe to demand. On learning the bribe amount demanded by (B), (E) decides whether to pay or not pay the bribe. The exemplary embodiments of this invention employ a similar approach to model a game between an auditor and a person that submits a claim for T & E, assuming both to be rational economic agents.

Embedded as a sub-problem of the Stackelberg game described above is a class of optimization problems studied by Sheopuri, A. and Zemel, E., “The Greed and Regret (GR) Problem” Working Paper, New York University. 2006. This class of problems has the following characteristic: a risk-neutral decision maker makes a decision in the face of uncertainty. His pay-off function is increasing in the decision variable up to a random cut-off and then decreases. These authors prove a number of theoretical results, such as supermodularity over the parameter space and show that a sufficient condition for this class of problems to have a unique solution is that the random variable which represents the uncertainty is IGFR(δ₁, δ₂). This class encompasses many commonly used distributions such as normal, uniform, Pareto, etc., for special cases of the problem. Further, Sheopuri and Zemel (2006) provide examples for some common distributions, such as the Uniform and Normal, where there is a one-to-one correspondence between the audit cut-off random variable and the optimal solution to the problem, for specific instances of the problem and for a given distribution. For the case of interest herein, one can restrict consideration to these classes of distributions. This restriction allows one to use the Weak Axiom of Revealed Preferences to determine the sufficient statistic of the distribution faced by the employee, having observed his fraud level. Note that though this is not necessary (one may deal with the problem of a non-unique mapping in multiple ways), it does facilitate the analysis.

The Weak Axiom of Revealed Preferences is defined herein as follows: If A, B feasible and A chosen, then at any prices and income where A,B are feasible, the consumer will choose A over B. This axiom says two things: 1) people choose what they prefer, and 2) preferences are consistent. Therefore, a single observed choice reveals a stable preference. Reference with regard to the Weak Axiom of Revealed Preferences can be made to “Lecture: Revealed Preference and Consumer Welfare”, David Autor, 14.03 Fall 2004.

With regard to the heuristic, a discussion is now made of the notation that is employed. Recall that a claim may be defined as containing “details pertaining to an expense incurred by the employee, with regard to date, expense type (airfare, lunch, etc.), location, payment type (cash or credit card), etc.” A claim record, c, is a vector of all the expense attributes available.

Let x represent relevant attributes of the claim record c, i.e., the vector of containing those attributes that are modeled as independent variables in the regression. Let β be the estimate of the coefficients of the Logit model M using the dependent variable as the best available imperfect audit proxy and the independent variables x. Let x_{R} be the relevant attributes of a particular record, R on which an auditing decision is to be made. Let c_{R} be the claim record corresponding to record R. Let p_{R} be the fraud level from the Logit model, M: Let

p_{R}=Λ(x_{R}^{T}β)

(Recall that Λ(.) is the cumulative distribution function of the Logistic distribution). Let H be the set of relevant attributes of the historical records of the claimant record c_{R}. Let p_{H} be the historical fraud level of the claimant from the Logit model M. Let Eₓ be the claim amount corresponding to the relevant attributes x of the claim c. Define

$${p}_{H} = \frac{{Σ}_{x ∈ H} {E}_{x} Λ ( {x}^{T} β )}{{Σ}_{x ∈ H} {E}_{x}} .$$

If R denotes the set of real numbers, let fₒ^{D}: F=R be a function from the space of sufficient statistics, F for a given parametric family of distributions D. Let S_{D}(X) be the tupple of sufficient statistics for a given distribution X belonging to the parametric family, D. Let

S_{D}(X_{R})=fₒ^{D}^{^{−1}}(p_{R})

and

S_{D}(X_{H})=fₒ^{D}^{^{−1}}(p_{H}).

Let X_{R}, X_{H} and X be the prior distribution of the audit cut-off for that record, historically and generically respectively. Let X′_{R} be the updated audit cut-off. Let Φ be the mechanism to update X_{R} to X′_{R}. Define

X′_{R}=Φ(X_{R},X_{H},X).

### Let p_{R}* be the updated optimal fraud level for the claim c_{R}. Define

p_{R}*=fₒ^{D}(X′_{R}).

Define the binary variable

$${b}_{{p}_{R}^{*}} ( {x}_{R} ) = \{ \begin{matrix}1 & {p}_{R}^{*} {E}_{{x}_{R}} - c > 0 ; ( 1 ) \\ 0 & o \text{/} w . ( 2 )\end{matrix} \qquad ( 3 )$$

As was stated above, the rationale for the heuristic is as follows. Due to the imperfect audit proxy, the statistical model, M, does not capture the decision making process of the claimant. As such, the exemplary embodiments of this invention model it explicitly. This is accomplished as follows (reference may be had again to FIG. 2).

A first step in the analysis is to build the discrete choice model with dependent variable as the imperfect fraud proxy, and independent variable(s) as factors that determine the auditing decision. In the mature automobile insurance fraud detection case an example would be the age of the claimant. Logit and Probit are two widely used discrete choice models. In that both models give similar results, the use of one over the other is a matter of design choice. Assume the use of a Logit model, M, that enables one to provide an initial estimate of fraud p_{R}, when a new claim, c, arrives. Note in this regard that if the proxy used to build the Logit model were a perfect proxy, then one would not need to update the estimate of p_{R}.

Due to the use of an imperfect audit proxy to built the Logit model, one is unable to capture the decision making process of the players perfectly. It is thus preferred to model the decision making process explicitly as a game between the claimant and the auditor, each trying to maximize his utility (or expected utility), knowing that the other is doing the same as well. Towards this end one may model, for simplicity and not as a limitation, the strategic interaction among the players as a single-period game. Note, however, that as an extension to the model a repeated game can be used. It is further assumed that the agents are risk-neutral, i.e., maximizing expected profit.

It can be shown that it is important to capture the historical behavior of the claimant. For example, if the claimant has been historically “bad”, one can expect that the claimant was more likely to submit a fraudulent claim. There are a number of alternatives that can be adopted to model this behavior, such as by computing weighted sums and assigning higher weights to more recent claims for the particular claimant. Adopted herein for simplicity, and not as a limitation, to capture the historical behavior of the employee 1 (claimant) is computing the weighted average, p_{H}, of the estimates of fraud of each individual historical claim of the claimant, with the weights being the claim amounts.

A next question to answer is how the following information is to be used:

(1) initial estimate of fraud level, p_{R};

(2) estimate of the historical fraud level of that employee, p_{H}; and,

(3) the prior distribution of the threshold of auditing, X.

One may employ the (GR) framework as a sub-problem of the game between the claimant and the auditor. One may also use the Weak Axiom of Revealed Preferences to identify the audit cut-off uncertainty, X_{H}, the random variable (r.v.) that the claimant faced historically given that he made a decision, p_{H}. Similarly, given that the claimant decided, p_{R}, one can determine the initial estimate of audit cut-off uncertainty, X_{R}, i.e., the r.v. that the claimant faced historically given that he made a decision. This, together with the prior distribution of the audit cut-off, X, enables one to update the estimate of the distribution from X_{R} to X′_{R}, which is the updated estimate of the distribution while deciding how much to cheat on that particular record. One simple method is to compute X′_{R} as the simple mean of X, X_{R} and X_{H}. Then one can update estimates of fraud to p_{R}* for that claim, given that the employee faced a distribution of X′_{R}. The decision of the auditor 6 is based on whether it is cost-effective for the auditor him to audit the claim or not.

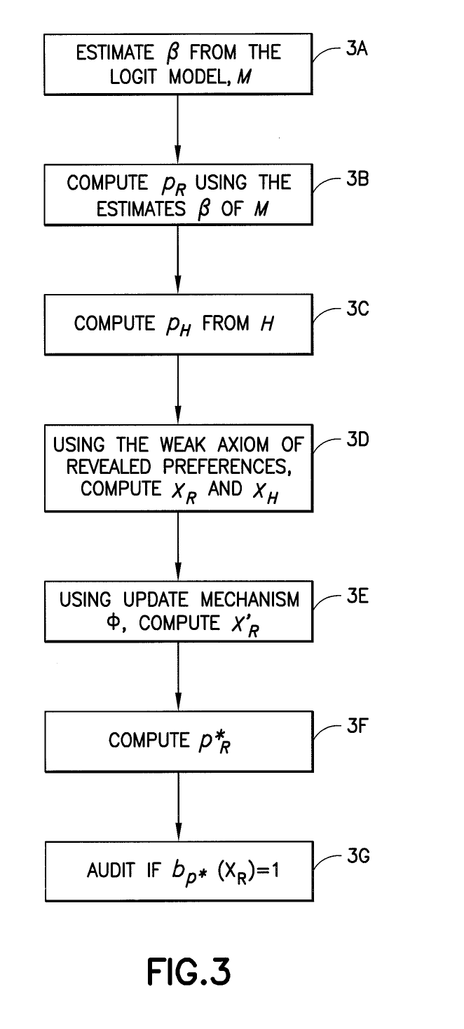

Based on the foregoing, and referring to FIG. 3, the heuristic can be stated as follows:
3A Estimate β from the Logit model, M.
3B Compute PR using the estimates β of M.
3C Compute p_{H} from H.
3D Using the Weak Axiom of Revealed preferences, compute X_{R} and X_{H}.
3E Using update mechanism Φ, compute X′_{R}.
3F Compute p_{R}*.
3G Audit if bₚ_{^{*}}(x_{R})=1.

Discussed now in further detail is the implementation of the heuristic for the non-limiting case of T&E expense management. Discussed first is the implementation of the statistical model 12, followed by the implementation of the overall game theory model 18, including the optimization function 14.

The first step in building the Logit model is to model the set of factors that explain the auditing decision. The analysis is exploratory and not hypothesis testing. As was explained earlier, being a nascent industry with respect to fraud detection there is no known prior theory in the T&E environment, which can be of assistance in building the model. However, the following factors are believed to be components in the auditing decision:

A. Expense amount: The amount of the claim in, or converted to, some monetary unit, such as USD (United States Dollars) (if necessary). As such, one may define:

Expenseₐₘₒᵤₙₜ=Expense amount in USD.

B. Expense type: Assume that there may be approximately 100 different expense types. Examples of what be considered a “core” expenses may include: BRK (breakfast), AIR (airfare), BENT (Business & Entertainment), CAR (car rental), FEESC (Food and Seminar), etc. However, one may observe that 5% of the expense types (core expenses) are associated with about 75% of the expense amount. This enables one to define a variable:

$${Expense}_{type} = \{ \begin{matrix}2 & Expense type ∈ \{ AIR , CAR \} ; \\ 1 & Expense type ∈ \{ DIN , BENT , FEESC \} ; \\ 0 & Expense type ∈ S \backslash \{ AIR , CAR , DIN , BENT , FEESC \} ,\end{matrix}$$

where S is the set of different expense types.

C. Receipt limit: For the USD amount above which a receipt is required, one may define the discrete variable:

$${Receipt}_{limit} = \{ \begin{matrix}0 & Receipt always required ; \\ 1 & Receipt required over threshold ; \\ 2 & Receipt never required .\end{matrix}$$

D. Expense description: As the dataset contains transactions that are cash as well as credit, one may define the binary variable:

$${Expense}_{description} = \{ \begin{matrix}0 & Expense is credit ; \\ 1 & Expense is cash .\end{matrix}$$

E. Expense country: There are potentially many different countries where expenses can be incurred. However, assume that approximately 80% of the expenses are incurred in one country (e.g., the USA). Other important expense locations can include Europe, India and China. One may then define a country variable:

$${Expense}_{country} = \{ \begin{matrix}1 & USA ; \\ 0 & others .\end{matrix}$$

Finally, using the notation introduced earlier,

x^{T}=(Expenseₐₘₒᵤₙₜ,Expense_{type},Receiptₗᵢₘᵢₜ,Expense_{description},Expense_{country}).

The table below shows which of the variables are statistically significant with a 99%, 95% and 90% confidence interval, respectively.

TABLE
Statistical significance of variables

| | | | | Sign of |
|---|---|---|---|---|
| Variable | 99% | 95% | 90% | coefficient |
| Expenseₐₘₒᵤₙₜ | No | No | No | Positive |
| Expense_{type} | Yes | Yes | Yes | Negative |
| Receiptₗᵢₘᵢₜ | No | No | Yes | Negative |
| Expense_{country} | Yes | Yes | Yes | Negative |
| Expense_{description} | Yes | Yes | Yes | Negative |

One may expect that the probability of fraud increases with the amount, if it is classified as a non-core expense (e.g., not one of AIR, CAR, BENT, DIN, FEESC), and if it occurred in a foreign (e.g., non-US) location . However, a result that “credit card claims are more likely to be fraudulent than cash claims” appears to be counterintuitive. This can be attributed to the fact that a deeper look into the rules that govern the imperfect audit proxy require certain type of credit card transactions to be flagged, while cash transactions are not. This is because it is easier to detect fraud during an audit for a credit card transaction.

Discussed now in further detail is the use of the Stackelberg Game to implement decision making under uncertainty, with regard to the optimization block 14 in FIG. 2.

As was explained above, a next step is to model the game between the employee and the auditor. One may model the employee's objective as the following special case of the (CS) problem:

$${Π}_{x} ( p ) = \{ \begin{matrix}{E}_{x} \cdot p & p \leq X ; ( 4 ) \\ 0 & p > X , ( 5 )\end{matrix} , \qquad ( 6 )$$

where the decision variable is the fraud level p given the claim x. Clearly, there are other alternatives for the profit function Π (for example, the objective function need not be piece wise linear). However, the function used for this implementation appears to be a natural choice. The employee's objective is to maximize his expected profit:

$${max}_{p ∈ C} E [ π ( p ) ] ,$$

where C is any convex set. In the application of interest herein one may model C=[0,1]. To understand the implementation of Step 3 C of the heuristic (FIG. 3), consider the special case when XU[0,a], 0<a≦1. The sufficient statistics of the distribution are the mean, μ and spread, Δ. Sheopuri and Zemel (2005) show that for this special case, the optimization problem has a unique solution. Let p* be that unique solution. Then, p*=a/2. Thus in this case,

$${f}_{o}^{D} ( μ , Δ ) = \frac{Δ}{2}$$

$$when μ = \frac{Δ}{2} and$$

$${f}_{o}^{{D}^{- 1}} ( x ) = ( x , 2 x ) .$$

A discussion is now made of the update mechanism, Φ, used in Step 3E of FIG. 3. The update mechanism uses:

$$Φ ( {X}_{1} , {X}_{2} , {X}_{3} ) = \frac{{X}_{1} + {X}_{2} + {X}_{3}}{3} ,$$

in a case where convolution maintains the family of distributions, for example, in the case of the normal distribution. Recall, however, that other simple distributions do not maintain the family under convolution of distributions. In that case, one may employ algebraic operations on the sufficient statistics. For example, in the case of the uniform distribution,

$$\begin{matrix}Φ ( {X}_{1} , {X}_{2} , {X}_{3} ) = Φ ( {X}_{1} ( {Δ}_{1} , {μ}_{1} ) , {X}_{2} ( {Δ}_{2} , {μ}_{2} ) , {X}_{3} ( {Δ}_{3} , {μ}_{3} ) ) \\ = X ( \frac{{Δ}_{1} + {Δ}_{2} + {Δ}_{3}}{3} , \frac{{μ}_{1} + {μ}_{2} + {μ}_{3}}{3} ) ,\end{matrix}$$

where Δᵢ is the spread and μᵢ is the mean of the uniform r.v. Xᵢ, i=1,2,3. Instead of a simple average, one may use a weighted average as well. The objective of the auditor 6 is to maximize his profit p*E−c, given the level of cheating p*.

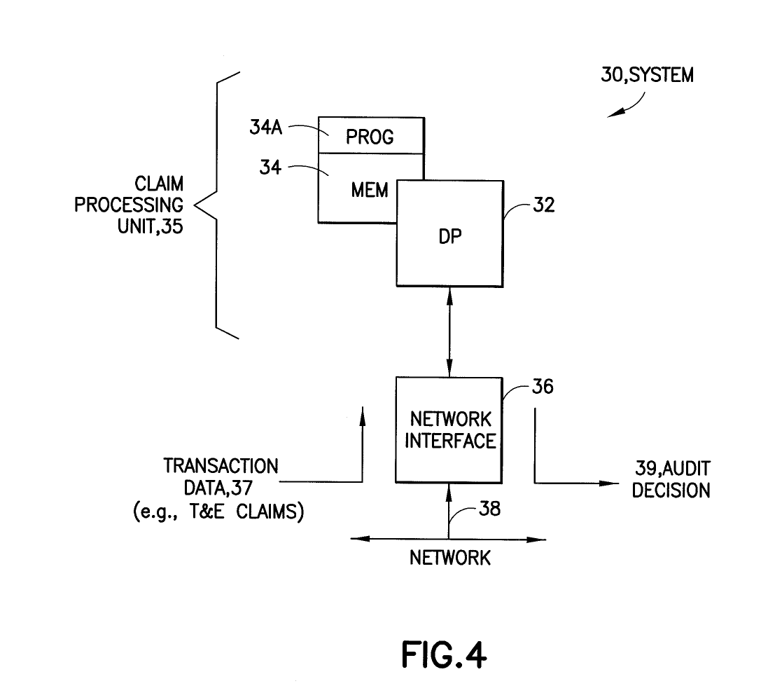

Reference is now made to FIG. 4 for showing a block diagram of a computing system 30 that is one suitable environment in which the invention may be embodied. The system 30 includes at least one data processor (DP) 32 that is coupled with at least one memory (MEM) 34. The memory 34 stores a program (PROG) 34A containing program instructions that, when executed by the data processor 32, results in the implementation of the methods discussed above, including those shown in FIGS. 2 and 3. The data processor 32, memory 34 and program 34A may be considered collectively to form a claim processing unit 35. The data processor 32 is coupled to a network interface 36 providing bi-directional communication with a data communication network 38. Transaction data 37, such as T&E claims, are input to the data processor 32 and are operated on by the program 34A to produce an audit decision 39 that is output through the network interface 36. In a no limiting embodiment the transaction data 37 can be received from the operational database 3 of FIG. 1, and the audit decision 39 can be output to the reporting database 4.

The system 30 can be embodied in any suitable form, including a main frame computer, a workstation and a portable computer such as a laptop. The data processor 32 can be implemented using any suitable type of processor including, but not limited to, microprocessor(s) and embedded controllers. The memory 34 can be implemented using any suitable memory technology, including one or more of fixed or removable semiconductor memory, fixed or removable magnetic or optical disk memory and fixed or removable magnetic or optical tape memory. The network 38 and network interface 36 can be implemented with any suitable type of wired or wireless network technology, and may include a local area network (LAN) or a wide area network (WAN), including the internet. Communication through the network can be accomplished at least in part using electrical signals, radio frequency signals and/or optical signals.

Based on the foregoing it should be appreciated that the inventors have disclosed a system, method and computer program product that implements a heuristic algorithm for fraud detection that overcomes the problem of the existence of only an imperfect fraud proxy. The heuristic algorithm combines elements of statistics (discrete choice models), optimization (decision making under uncertainty) and game theory (e.g., the Stackelberg game). The use of the exemplary embodiments of this invention provides a framework for studying fraud detection in the case of nascent industries where a perfect (e.g., well characterized fraud proxy) is not available.

The model provides an ‘easy-to-understand’ intuitive approach to the fraud detection problem, and in one aspect thereof assumes the players (the claimant and the auditor) to be rational economic agents so as to model their decision making processes. This enables the model to capture the strategic behavior of the player(s). The behavior may be modeled as a single period game or as a repeated game, where if the model is established as a repeated game the equilibrium probabilities may be lower and may be randomized. These can be readily incorporated into the model in a heuristic way by adding a random noise to the fraud level.

It should be noted that while the foregoing description has been presented in the context of detecting fraud in claims, there are other possible modeling opportunities for managing the process. For example, one problem that may be of relevance in the management of claims is cash-flow management: managing cash flows by means of a trade-off between the opportunity cost of stocking an extra dollar and the loss of good-will of stocking too little. The process may be set up as a dynamic optimization problem to minimize expected future costs over a finite (or infinite) horizon (see, for example, Porteus, Evans, 2005, “Foundations of Stochastic Inventory Theory” (2002)). The decision variable is to decide the cash pool to stock in a period to meet random demand on the pool (estimated from historical data).

Based on the foregoing description it should be appreciated that the exemplary embodiments of this invention provide in one aspect thereof a computer-implemented method for decision making by means of a game theory refinement, taking input from a statistics model. The statistics model may use any available or derived perfect or imperfect proxy as a dependent variable, where the independent variables may be any attributes available or derived from the data. The computer-implemented method enables decision making for transaction data, and use the statistics model for estimating the probabilities of decisions, employs decision making under uncertainty to update estimates of the probability of decisions and uses game theory to model strategic behavior between economic agents.

The exemplary embodiments of this invention provide in a further aspect thereof computer-implemented method for fraudulent claim detection by means of game theory refinement, taking input from the statistics model. The statistics model may use any available or derived perfect or imperfect proxy as the dependent variable of fraudulent claims, the independent variables being any attributes available or derived from the data. The fraudulent claims detection may be applied in the area of T&E, but is clearly not limited for use in only this one particular area.

Stated differently, the exemplary embodiments of this invention provide in another aspect thereof a computer-implemented method for discrete choice decision making by means of game theory refinement, taking input from the statistics model.

Stated differently, the exemplary embodiments of this invention provide in another aspect thereof a computer-implemented method for discrete choice decision making by means of game theory refinement, taking input from a discrete choice model.

In the foregoing non-limiting aspects the probabilities of discrete choice may be updated using the weak axiom of revealed preferences, or any other mechanism that resolves the uncertainty in decision making, and combining some or all of the information pertaining to generic and historical information. The discrete choice decision may be based on an ad hoc decision on observing the updated probability, or on the utility of the economic agent. The discrete choice decision making may employ a Logit or Probit model, with the imperfect proxy as the dependent variable and the independent variables being any of those attributes available or derived from the data.

Various modifications and adaptations may become apparent to those skilled in the relevant arts in view of the foregoing description, when read in conjunction with the accompanying drawings and the appended claims. As but some examples, the use of other similar or equivalent types of claim-related data may be attempted by those skilled in the art. However, all such and similar modifications of the teachings of this invention will still fall within the scope of this invention.

Furthermore, some of the features of the examples of this invention may be used to advantage without the corresponding use of other features. As such, the foregoing description should be considered as merely illustrative of the principles, teachings, examples and exemplary embodiments of this invention, and not in limitation thereof.

What is claimed is:

1. A computer-implemented method to make a decision as to whether a particular claim submitted by a first economic agent for approval by a second economic agent may be a fraudulent claim, comprising:
applying statistics to information representing a proxy of fraud to generate an estimate of a probability of fraud for the particular claim;
updating the estimate of the probability of fraud using decision making under uncertainty that is based at least in part on at least one type of additional information;
applying game theory to the updated estimate of the probability of fraud to model strategic behavior between the first and second economic agents; and
generating a recommendation to audit or not audit the particular claim.

2. The computer-implemented method of claim 1, where a statistics model uses an available or a derived perfect or imperfect proxy as a dependent variable, and where independent variables may be available attributes or derived attributes.

3. The computer-implemented method of claim 1, where the particular claim comprises an expense report claim.

4. The computer-implemented method of claim 1, where applying game theory applies a Stackelberg game.

5. The computer-implemented method of claim 1, where applying statistics comprises statistical modeling using a discrete choice model.

6. The computer-implemented method of claim 5, where using a discrete choice model comprises using one of a Logit or Probit model with an imperfect proxy of fraud as a dependent variable.

7. A computer program product embodied on a tangible memory media and comprising program instructions the execution of which by a data processor result in operations to detect if a particular claim submitted by a first economic agent for approval by a second economic agent may be a fraudulent claim, comprising operations of:
applying a statistic model to information representing an imperfect proxy of fraud to generate an estimate of a probability of fraud for the particular claim;
updating the estimate of the probability of fraud using decision making under uncertainty that is based at least in part on at least one type of additional information;
using game theory with the updated estimate of the probability of fraud to model strategic behavior between the first and second economic agents; and
generating a recommendation to audit or not audit the particular claim.

8. The computer program product of claim 7, where the statistics model uses the imperfect proxy of fraud as a dependent variable, and where independent variables may be available attributes or derived attributes.

9. The computer program product of claim 7, where the particular claim comprises an expense report claim.

10. The computer program product of claim 7, where using game theory comprises using a Stackelberg game.

11. The computer program product of claim 7, where applying statistics comprises statistical modeling using a discrete choice model.

12. The computer program product of claim 11, where using a discrete choice model comprises using one of a Logit or Probit model with the imperfect proxy of fraud as a dependent variable.

13. A data processor comprising:
an input for receiving a claim submitted by a first economic agent for approval by a second economic agent;
a claim processing unit coupled to the input and adapted to detect if the claim may be a fraudulent claim; and
an output coupled to the claim processing unit for outputting a recommendation to audit or not audit the claim;
where said claim processing unit is adapted to apply a statistic model to information representing an imperfect proxy of fraud to generate an estimate of a probability of fraud for the claim, to update the estimate of the probability of fraud using decision making under uncertainty that is based at least in part on at least one type of additional information, and to use game theory with the updated estimate of the probability of fraud to model strategic behavior between the first and second economic agents.

14. The data processor of claim 13, where the statistics model uses the imperfect proxy of fraud as a dependent variable, and where independent variables may be available attributes or derived attributes.

15. The data processor of claim 13, where the claim comprises an expense report claim.

16. The data processor of claim 13, where the data processor when using game theory uses a Stackelberg game.

17. The data processor of claim 13, where the data processor when applying statistics applies a statistical model comprised of a discrete choice model.

18. The data processor of claim 17, where the data processor when using the discrete choice model comprises using one of a Logit or Probit model with the imperfect proxy of fraud as a dependent variable.

19. A computer program product embodied on a tangible memory media and comprising program instructions the execution of which by a data processor result in operations to make an auditing decision for a claim submitted by a claimant, the operations comprising:
estimating β from a statistical model, M;
computing p_{R} using the estimate β of M;
computing p_{H} from H;
using a Weak Axiom of Revealed preferences, computing X_{R} and X_{H};
using update mechanism Φ, compute X′_{R};
computing p_{R}*; and
making an affirmative audit decision if bₚ_{^{*}}(x_{R})=1;
where x represents relevant attributes of a claim record C, where β is an estimate of coefficients of M using a dependent variable as a best available imperfect audit proxy and independent variables x, where x_{R} are relevant attributes of a particular record, R, on which an auditing decision is to be made, where c_{R} is a claim record corresponding to record R, where p_{R} is a fraud level from the model, M and is given by
p_{R}=Λ(x_{R}^{T}β),
where Λ(.) is a cumulative distribution function of logistic distribution, where H is a set of relevant attributes of historical records of record c_{R}, where p_{H} is a historical fraud level of the claimant from the model M, where Eₓ is a claim amount corresponding to relevant attributes x of the claim C, and where p_{H} is given by
$${p}_{H} = \frac{{Σ}_{x ∈ H} {E}_{x} Λ ( {x}^{T} β )}{{Σ}_{x ∈ H} {E}_{x}} .$$
where X_{R}, X_{H} and X are the prior distribution of the audit cut-off for a record, historically and generically, respectively, where X′_{R} is an updated audit cut-off and Φ is a mechanism to update X_{R} to X′_{R} such that
X′_{R}=Φ(X_{R},X_{H},X).
where p_{R}* is an updated optimal fraud level for the claim c_{R} and is given by
p_{R}*=fₒ^{D}(X′_{R}).
and where the binary variable is defined as
$${b}_{{p}_{R}^{*}} ( {x}_{R} ) = \{ \begin{matrix}1 & {p}_{R}^{*} {E}_{{x}_{R}} - c > 0 ; ( 1 ) \\ 0 & o \text{/} w . ( 2 )\end{matrix} \qquad ( 3 )$$

20. The computer program product as in claim 19, where the claim comprises a travel and expenses claim.
